(19) United States
(12) Patent Application Publication
(10) Pub. No.: US 2014/0351715 A1
(43) Pub. Date: Nov. 27, 2014

(54) SYSTEM FOR TRACKING AN ACTIVE REGION ON A SMALL SCREEN DURING A SHARE SESSION

(71) Applicant: Cisco Technology, Inc., San Jose, CA (US)

(72) Inventors: Haihua Huang, Suzhou (CH); Yong Qian, Suzhou (CH); Yaqing Zhang, Peixian County (CH); Kejun Xia, Suzhou (CH)

(73) Assignee: Cisco Technology, Inc., San Jose, CA (US)

(21) Appl. No.: 13/898,710

(22) Filed: May 21, 2013

(51) Int. Cl. H04L 29/06

(52) U.S. Cl. CPC H04L 65/403
USPC 715/753

(57) ABSTRACT

In one embodiment, a method includes establishing a communications session between a first endpoint that displays a shared desktop and a second endpoint that has a display screen, identifying an active region that is part of the shared desktop, and providing an interface on the second endpoint that obtains an input that indicates whether a representation of the active region is to be automatically displayed on the display screen. An input is obtained, and it is determined when the input indicates that the representation is to be automatically displayed on the display screen in response to the input. If the input indicates that the representation is to be automatically displayed on the display screen, the representation is displayed on the display screen. The representation is automatically displayed on the display screen such that substantially only the representation is displayed on the display screen.

### TECHNICAL FIELD

The disclosure relates generally to telephony and unified communications. More particularly, the disclosure relates a system for efficiently allowing a user of a device with a relatively small display screen to efficiently display an active region associated with a desktop share session during a communications session.

### BACKGROUND

Group meetings often involve online conferences and/or desktop sharing sessions. During such meetings, content is often shared by one party, e.g., a presenter, such that the content is viewed by other parties, e.g., attendees. For example, a presenter may share the desktop of his or her computing device such that attendees may view the desktop while the presenter manipulates content on the desktop.

Attendees of online conferences and/or desktop sharing sessions often participate in the online conferences and/or desktop sharing sessions using mobile devices such as cellular phones. As a presenter in an online conference and/or desktop sharing session may present content using the display screen of his or her personal computer as a shared screen, an attendee who is participating in the online conference and/or desktop sharing session using a mobile device may be unable to display and view the entirety of the shared screen on the mobile device. As will be appreciated by those skilled in the art, the resolution of a display screen of a personal computer is generally much higher than the resolution of a display screen of a mobile device and, hence, the contents displayed on the display screen of a personal computer typically are not all displayed on the display screen of the mobile device.

During a desktop sharing session, an attendee who is participating in the desktop sharing session using a mobile device or, more generally, a device with a display screen that is relatively small, may be unable to efficiently locate pertinent regions of a shared desktop. For example, a presenter may highlight a particular region of a shared desktop, and an attendee may be unable to locate and display the particular region on a display screen of his or her mobile device until after the presenter is no longer highlighting the particular region. As a result, the attendee may miss important elements highlighted during the desktop sharing session, thereby diminishing his or her user experience.

### BRIEF DESCRIPTION OF THE DRAWINGS

The disclosure will be readily understood by the following detailed description in conjunction with the accompanying drawings in which:

FIG. 1 is a block diagram representation of a network that supports an ability for an active region associated with a shared desktop to be efficiently displayed on a relatively small screen, e.g., a screen on a mobile device such as a cellular phone, during a desktop sharing session in accordance with an embodiment.

FIG. 2 is a diagrammatic representation of an active region of a displayed desktop, e.g., a desktop displayed in a display screen of a computing device during a desktop sharing session, in accordance with an embodiment.

FIGS. 3A-D are a process flow diagram which illustrate a method of causing a region of a shared desktop, e.g., an active region of the shared desktop, to be displayed on a relatively small screen during a desktop sharing session in accordance with an embodiment.

FIG. 4 is a diagrammatic representation of a mobile device on which a navigation bar that depicts a display region and an active region of a shared desktop is displayed in accordance with an embodiment.

FIG. 5A is a diagrammatic representation of a screen of a mobile device relative to an active region of a desktop at a time t1 during a desktop sharing session in accordance with an embodiment.

FIG. 5B is a diagrammatic representation of a screen of a mobile device, e.g., screen 544 of mobile device 540 of FIG. 5A, relative to an active region of a desktop at a time t2 after substantially direct scrolling has enabled the active region to be displayed on the screen during a desktop sharing session in accordance with an embodiment.

FIG. 5C is a diagrammatic representation of a screen of a mobile device, e.g., screen 544 of mobile device 540 of FIG. 5A, relative to an active region of a desktop at a time t2 after horizontal then vertical scrolling has enabled the active region to be displayed on the screen during a desktop sharing session in accordance with an embodiment.

FIG. 5D is a diagrammatic representation of a screen of a mobile device, e.g., screen 544 of mobile device 540 of FIG. 5A, relative to an active region of a desktop at a time t2 after vertical then horizontal scrolling has enabled the active region to be displayed on the screen during a desktop sharing session in accordance with an embodiment.

### DESCRIPTION OF EXAMPLE EMBODIMENTS

### General Overview

According to one aspect, a method includes establishing a communications session between a first endpoint and a second endpoint. The first endpoint is arranged to display a shared desktop and the second endpoint has a display screen, wherein the shared desktop is arranged to be shared during the communications session. The method also includes identifying an active region that is part of the shared desktop, and providing an interface on the second endpoint arranged to obtain an input. The input is arranged to indicate whether a representation of the active region is to be automatically displayed on the display screen in response to the input. An input is obtained through the interface, and it is determined when the input indicates that the representation of the active region is to be automatically displayed on the display screen in response to the input. When it is determined that the input indicates that the representation of the active region is to be automatically displayed on the display screen, the method includes causing the representation of the active region to be displayed on the display screen. The representation of the active region is automatically displayed on the display screen such that substantially only the representation of the active region is displayed on the display screen.

### DESCRIPTION

During collaboration sessions, e.g., online conferences and/or desktop sharing sessions, some parties may participate in the sessions using devices with relatively small display screens. Devices with relatively small display screens may include, but are not limited to including, mobile devices such as cellular phones and tablet computing devices. When parties participate in collaboration sessions using devices with relatively small display screens, those parties may experience difficulty in locating an “active region” of a shared desktop, or a region of the shared desktop that is currently being substantially highlighted by, as for example manipulated by, a presenter. If a party has to manually scroll through his or her display screen in an effort to locate and to display a currently active region of a shared desktop during a collaboration session, the party may waste valuable time and may be unable to fully participate in the collaboration session.

In one embodiment, an active region is defined with respect to a desktop that is shared during a desktop sharing session. The active region may generally be defined as an area on a desktop that is currently being highlighted or manipulated, e.g., updated. Information relating to the active region is provided to a device that is used by a participant to participate in the desktop sharing session, and the device may readily display the active region. The participant may elect to have the active region be displayed substantially automatically, as for example such that a current active region is automatically displayed on the device of the participant each time the current active region changes. Alternatively, a participant may manually select an active region for display, e.g., the participant may activate a button or the like on his or her device which causes a current active region to be displayed automatically upon the manual activation of the button or the like. By providing information relating to an active region, the active region may be readily displayed on the device of the participant, as for example on the screen of a mobile device in the possession of the participant. Thus, the participant may more easily follow along with the desktop sharing session, and efficiently view the active region.

When a mobile user who is participating in an online meeting and/or desktop sharing session is able to efficiently view the region of a shared desktop that is currently being manipulated, the likelihood of the mobile user losing focus may be reduced. Further, the amount of time spent by the mobile user to identify the region of a shared desktop that is currently being highlighted, e.g., manipulated, may be significantly reduced. For example, the need for the user to manually scroll through regions associated with a shared desktop to locate the active region may effectively be eliminated. As such, the experience of the mobile user during the online meeting and/or desktop sharing session may be enhanced.

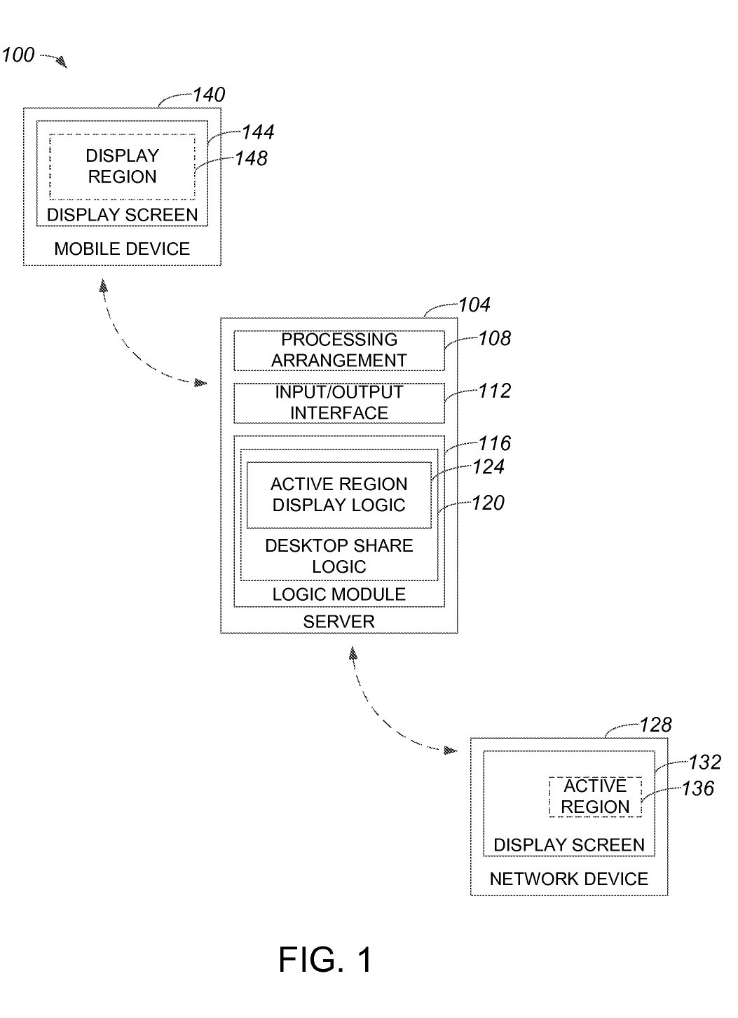

Referring initially to FIG. 1, a network that supports an ability for an active region associated with a shared desktop to be efficiently displayed on a relatively small screen, e.g., a screen on a mobile device such as a cellular phone, during a desktop sharing session in accordance with an embodiment. A network 100, e.g., a communications network, includes a server 104, a network device 128, and a mobile device 140. Server 104, network device 128, and mobile device 140 may be in communication over wireless and/or wired communications links (not shown).

Server 104 is generally arranged to facilitate a communications session, e.g., an online collaboration session and/or a desktop sharing session, in which network device 128 and mobile device 140 participate. Network device 128 and mobile device 140 may generally be endpoints associated with the communications session. In the described embodiment, network device 128 is associated with a presenter in the communications session and, thus, a desktop portrayed on a display screen 132 of device 128 is effectively shared such that mobile device 140 may view at least part of the desktop on a display screen 144. That is, mobile device 140 may be associated with an attendee of the communications session.

Network device 128 may be any suitable communications device that may share a desktop. That is, network device 128 may be a communications device that hosts a desktop which may be shared during a communications session. Network device 128 may be, but is not limited to being, a personal computer system that includes a display screen. Mobile device 140 may be, but is not limited to being, a cellular phone or a tablet computer. In general, mobile device 140 may be any communications device in which display screen 144 is smaller in size than display screen 132 of network device 128. It should be appreciated that although server 104 and network device 128 are shown as separate elements within network 100, the functionality of server 104 may be included in network device 128 in some embodiments, e.g., server 104 and network device 128 may be associated with a single network element.

Server 104 includes a processing arrangement 108, an input/output (I/O) interface 112, and a logic module 116. I/O interface 112 is a communications interface which allows server 104 to exchange information with mobile device 140 and network device 128, and generally includes at least one I/O port (not shown). Logic module 116 includes hardware and/or software logic, as for example computer readable program code that is arranged to be executed by processing arrangement 108.

Logic module 116 includes desktop share logic 120 configured to allow contents displayed on display screen 132 to be displayed at least in part on display screen 144. Active region display logic 124, which is included in desktop share logic 120, is configured to identify an active region 136 displayed on display screen 132. Active region 136 is an area of a desktop displayed on display screen 132 that is currently being manipulated. By way of example, active region 136 may be an area on a desktop displayed on display screen 132 that a user of network device 128 is highlighting or editing.

Active region display logic 124 identifies active region 136, and may provide information which identifies active region 136 to mobile device 140 such that mobile device 140 may elect to have a representation of active region 136 displayed in display region 148. It should be appreciated that active region 136 is typically smaller in size than the entire desktop displayed on display screen 132, and that the representation of active region 136 is sized to substantially fill display region 148. In other words, when a representation of active region 136 is presented in display region 148, the size of the representation may be scaled such that substantially only the representation of active region 136 is presented in display region 148. In one embodiment, display screen 144 and display region 148 have approximately the same surface area.

Any suitable method may be used by active region display logic 124 to identify or otherwise define active region 136. By way of example, active region display logic 124 may define active region 136 using information provided by network device 128 relating to the movement of a cursor on display screen 132. Alternatively, active region display logic 124 may identify changes in pixels visible on display screen 132, and may define an active area to be an area with the greatest number of pixel changes within a particular time period.

Active region display logic 124 may provide mobile device 140 with an option to have a representation of active region 136 automatically displayed in display region 148. That is, active region display logic 124 may be configured to support an “auto-switch” mode which allows a representation of active region 136 to be automatically displayed in display region 148 whenever active region 136 changes, or is updated.

Active region display logic 124 may also provide mobile device 130 with an option to elect to display a current representation of active region 136 in display region 148. It should be appreciated that the option to elect to display a current representation of active region 136 in display region 148 may allow a user of mobile device 140 to effectively substantially instantaneously cause the current representation of active region 136 to be displayed in display region 148, e.g., without having to manually scroll through or over a representation of the entirety of the desktop displayed on display screen 132.

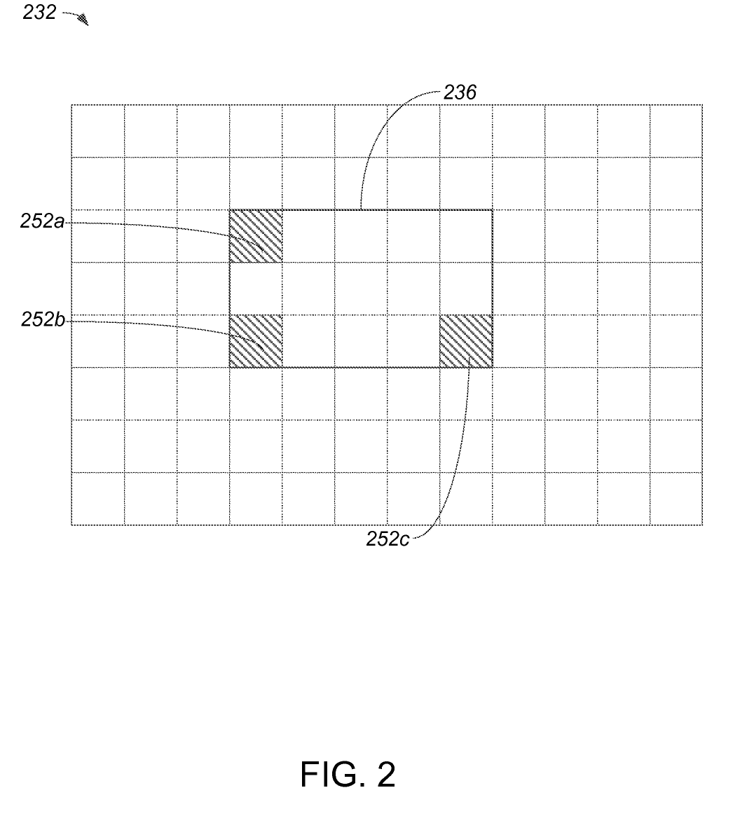

In some instances, active region 136 may effectively be larger than what can be displayed in display region 148. When active region 136 is effectively larger than what can be displayed in display region 148, parts of active region 136 may be represented in display region 148. For example, a representation of an approximate center of active region 136 may be displayed in display region 148 such that “edges” of active region 136 are not represented within display region 148. That is, a center region of active region 136 may be represented in display region 148 while other parts of active region 136 fall outside of display region 148. Alternatively, a portion of active region 136 represented in display region 148 may effectively be centered around an update region (not shown) in active region 136 that has been updated the most frequently within a given time period. An update region (not shown), which will be discussed below with respect to FIG. 2, may be a portion of active region 136 which has been manipulated within a particular time period. It should be appreciated that identifying an update region (not shown) in active region 136 that has been updated the most frequently generally involves tracking how often different blocks (not shown) associated with active region 136 are updated.

As previously mentioned, active region display logic 124 is configured to identify active region 136. With reference to FIG. 2, one method of identifying an active region will be described. FIG. 2 is a diagrammatic representation of an active region of a displayed desktop, e.g., a desktop displayed in a display screen of a computing device during a desktop sharing session, in accordance with an embodiment. A display screen 232 may be considered to be a matrix of blocks or regions. That is, display screen 232 may effectively be divided into a plurality of blocks. The number of blocks and the size of each block, e.g., the number of pixels associated with each block, may vary widely.

As shown, blocks 252a-c are considered to be update regions, or regions in which the contents displayed therein have been recently manipulated, or manipulated within a particular time frame. Contents may be considered to be manipulated if the contents have been moved, updated, or otherwise changed, and/or if a cursor is moving over the contents. An active region 236 may be defined to be the smallest rectangle which encompasses a given number of update regions. In the described embodiment, active region 236 is the smallest rectangle which encompasses update regions 252a-c. As shown, the smallest rectangle which encompasses update regions 252a-c is a rectangle which includes fifteen blocks, and is three blocks high and five blocks wide.

It should be appreciated that the number of update regions 252a-c used to define active region 236 may vary widely. In some instances, active region 236 may be defined by a single update region. Generally, active region 236 may be defined to be the smallest rectangle which encompasses substantially all update regions 252a-c which have been updated within a particular time period. For instance, active region 236 may be defined to be the smallest number of blocks which form a rectangle that encompasses substantially all update regions 252a-c which have been updated within a particular amount of time, e.g., approximately three seconds.

Typically, active region 236 is smaller than display screen 232. In other words, active region 236 has a smaller area than is covered by a desktop displayed on display screen 232, i.e., active region 236 generally includes less than the total number of blocks associated with display screen 232.

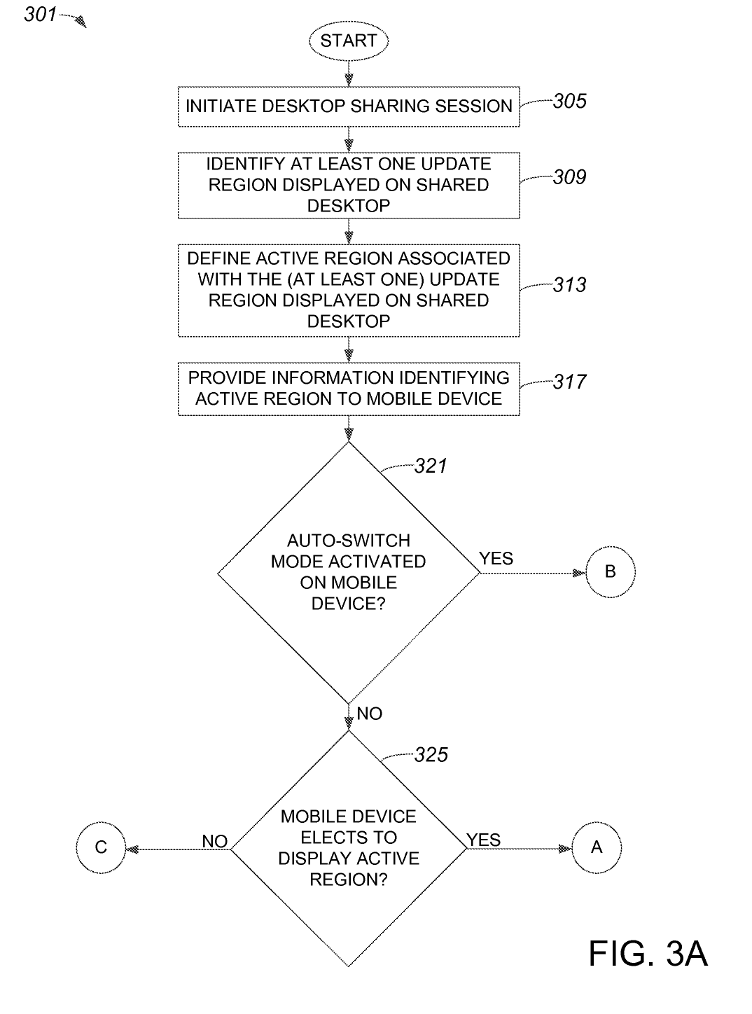

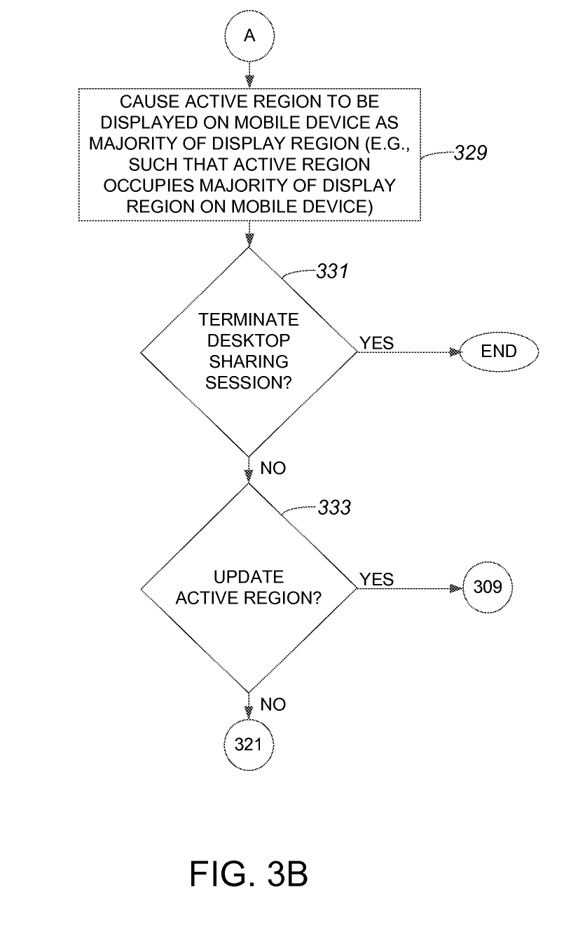

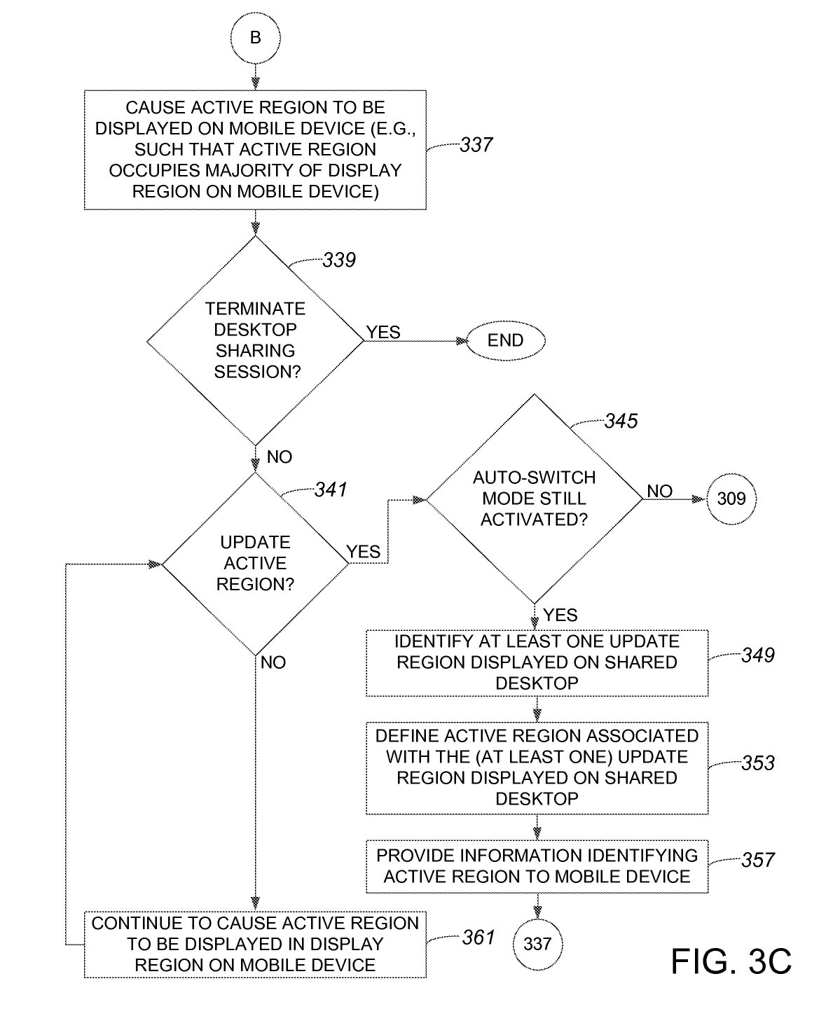

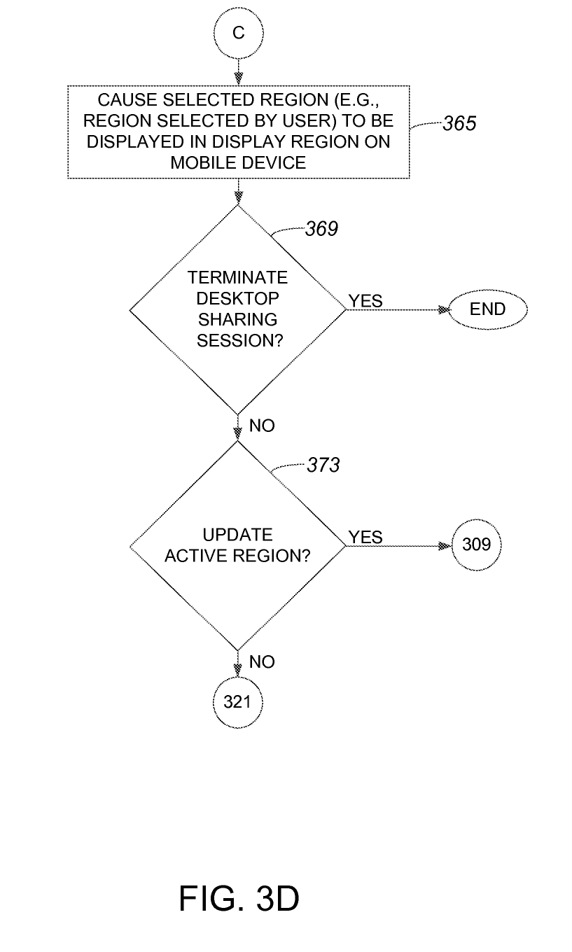

FIGS. 3A-D are a process flow diagram which illustrate a method of causing a region of a shared desktop, e.g., an active region of the shared desktop, to be displayed on a relatively small screen during a desktop sharing session in accordance with an embodiment. A process 301 of causing an active region or, more specifically, a representation of the active region of a shared desktop to be displayed or rendered on a relatively small screen, from the point of view of a server which facilitates a desktop sharing session, beings at step 305 in which a desktop sharing session is initiated. The desktop sharing session may be initiated by a server, e.g., a conference server, in response to a request from a network element with a desktop to be shared and/or a device with a relatively small screen, e.g., a mobile device. When a desktop sharing session is initiated, the desktop rendered on a display screen associated with the network element may be shared with the mobile device. That is, the desktop displayed on a display screen of the network element is shared with participants in the desktop sharing session.

In step 309, at least one update region displayed on the shared desktop is identified once the communications session is established. Identifying at least one update region includes, but is not limited to including, determining when the shared desktop is being manipulated and determining how many blocks or defined areas of the shared desktop have been manipulated within a particular amount of time. Blocks or areas manipulated within a particular amount of time are generally considered to be update regions.

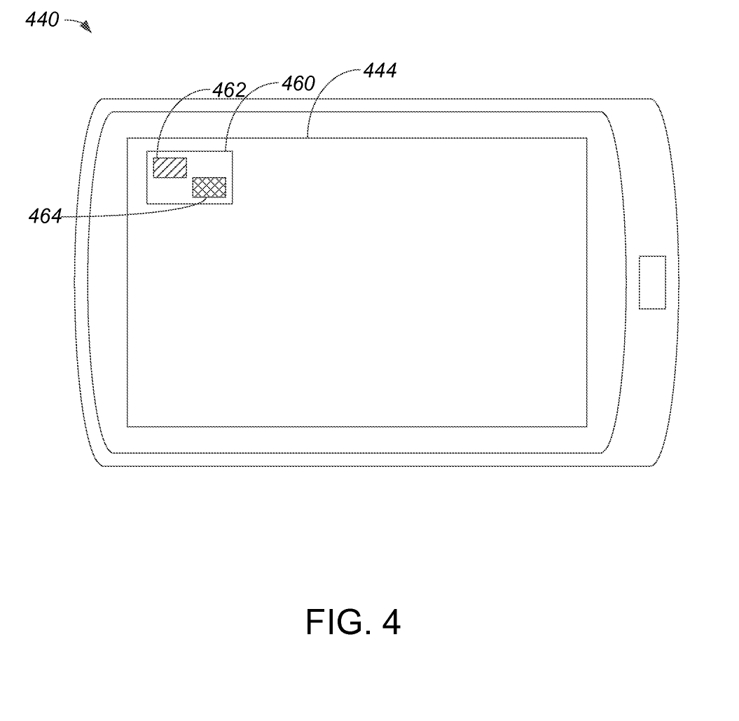

After at least one update region displayed on the shared desktop is identified, an active region is defined in step 313. As previously mentioned, an active region may be defined to be a smallest rectangle which encompasses the update regions identified in step 309. Once the active region is defined, information that identifies the active region is provided in step 317 to a mobile device that is a part of the desktop sharing session. The information may be provided in any suitable format. In one embodiment, the information may be provided in a navigation menu, e.g., a navigate bar, that allows a user of a mobile device to readily cause a display region of the mobile device to effectively automatically scroll such that a representation of the active region is displayed in the display region. One suitable navigation bar will be discussed below with reference to FIG. 4.

A determination is made in step 321 as to whether an auto-switch mode is activated on the mobile device. An auto-switch mode is configured to allow a display region on a mobile device to automatically scroll such that a representation the active region of a shared desktop is shown in the display region each time the active region of the shared desktop is updated.

If the determination in step 321 is that an auto-switch mode has not been activated on the mobile device, then it is determined in step 325 whether the mobile device elects to display the active region. A user of the mobile device may elect to display the active region, e.g., through the use of a navigation bar.

When it is determined in step 325 that the mobile device has elected to display the active region, process flow moves to step 329 in which a representation of the active region is displayed on the mobile device in the display region. In general, the server which supports the desktop share session may cause the representation of the active region to be displayed in the display region such that the representation of the active region essentially occupies a majority of the display region. Causing the representation of the active region to be displayed in the display region may involve automatically scrolling the display region over a representation of the shared desktop until the representation of the active region is displayed within the display region, in response to the election to display the active region.

Scrolling a display region over a representation of a shared desktop generally involves panning a view within the display region across the representation of the shared desktop, or otherwise essentially sliding the representation of the shared desktop across the display region. As will be appreciated by those skilled in the art, scrolling may include, but is not limited to including, horizontal and/or vertical movement.

Once a representation of the active region is displayed in the display region on the mobile device, it is determined in step 331 whether the desktop sharing session is to be, or has been, terminated. If it is determined that the desktop sharing session is to be or has been terminated, process 301 of causing an active region of a shared desktop to be displayed on a relatively small screen is completed upon terminating the desktop sharing session.

Alternatively, if the desktop sharing session is not to be or has not been terminated, the process flow moves to step 333 in which it is determined whether the active region is to be updated. Determining whether the active region is to be updated may include, but is not limited to including, determining whether a particular amount of time has elapsed since the active region was last defined and/or determining whether there have been a particular number of regions of the shared desktop which have been updated since the active region was last defined.

If it is determined that the active region is to be updated, then the indication is that a particular amount of time has elapsed. Accordingly, process flow returns to step 309 in which at least one update region displayed on the shared desktop is identified. If, however, the determination is that the active region is not to be updated, then process flow returns to step 321 in which it is determined whether the auto-switch mode has been activated on the mobile device.

Returning to step 321, if it is determined that the auto-switch mode has been activated on the mobile device, he implication is that each time an active region is updated, the display region on the mobile device substantially automatically displays a representation of the updated, or current, active region. As such, a representation of the active region is substantially automatically displayed on the mobile device in step 337, as for example such that the active region occupies a majority of the display region on the mobile device. After the representation of the active region is displayed on the mobile device, it is determined in step 339 whether the desktop sharing session is to be, or has been, terminated.

If the determination in step 339 is that the desktop sharing session is to be, or has been, terminated, process 301 of causing an active region of a shared desktop to be displayed on a relatively small screen is completed. Alternatively, if the determination in step 339 is that the desktop sharing session is not to be, or has not been, terminated, a determination is made in step 341 as to whether the active region is to be updated.

If it is determined in step 341 that the active region is not to be updated, then a representation of the active region, i.e., the active region displayed in step 337, continues to be displayed in the display region on the mobile device in step 361. From step 361, process flow returns to step 341 in which it is determined whether the active region is to be updated.

When it is determined in step 341 that the active region is to be updated, then it is determined in step 345 whether the auto-switch mode is still activated. If the determination is that the auto-switch mode is not still activated, then process flow returns to step 309 in which at least one update region displayed on the shared desktop is identified.

Alternatively, if it is determined in step 345 that the auto-mode switch is still activated, at least one update region displayed on the shared desktop is identified in step 349. Once at least one update region displayed on the shared desktop is identified, a new or updated active region is defined in step 353. Information that identifies the active region is provided to the mobile device in step 357, and process flow returns to step 337 in which a representation of the active region, i.e., the active region defined in step 353, is displayed.

Referring back to step 325 and the determination of whether the mobile device elects to display the active region, if the determination is that the mobile device has not elected to display the active region, then a representation of a selected region is displayed in the display region on the mobile device in step 365. The selected region may generally be any region that a user of the mobile device selects, as for example by manually scrolling.

After the representation of the selected region is displayed in step 365, it is determined in step 369 whether the desktop sharing session has been terminated. If it is determined that the desktop sharing session has been terminated, process 301 of causing an active region of a shared desktop to be displayed on a relatively small screen is completed. Alternatively, if it is determined that the desktop sharing session has not been terminated, a determination is made in step 373 as to whether the active region is to be updated.

If it is determined in step 373 that the active region is to be updated, the process flow returns to step 309 in which at least one update region displayed on the shared desktop is identified. If, however, it is determined in step 373 that the active region is not to be updated, then process flow proceeds to step 321 in which a determination is made as to whether the auto-switch mode is activated on the mobile device.

A user of a mobile device may generally be provided with any suitable user interface which provides the user with an ability to activate an auto-switch mode and/or an ability to cause a representation of an active region of a shared display to be displayed in a display region of the mobile device substantially on-demand. A suitable user interface may include, but is not limited to including, a navigation bar, a drop-down menu, and/or a pop-up window. By way of example, a navigation bar may include an icon for a display region and another icon for a representation of an active region of a shared display, and may be arranged such that a user may cause the representation of the active region to be displayed in a display region of a mobile device by essentially activating the icon for the representation of the active region. In other words, a navigation bar may be configured to allow a user to provide input that allows the user to effectively switch from displaying a representation of one region of a shared desktop to displaying a representation of another region, e.g., an active region, of the shared desktop. It should be understood that the representations of the regions of the shared desktop may be of approximately the same scale, i.e., the representations may have the same associated scale-rate.

FIG. 4 is a diagrammatic representation of a mobile device on which a navigation bar that depicts a display region and an active region of a shared desktop is displayed in accordance with an embodiment. A mobile device 440, e.g., a cellular phone or a tablet computing device, that may be used to participate in a desktop sharing session includes a display screen 444. A navigation bar 460 is displayed on display screen 444, and is configured to allow a user to readily locate an active region of a shared desktop. As shown, navigation bar 460 is displayed in a corner of display screen 444. It should be appreciated, however, that navigation bar 460 may generally be displayed substantially anywhere on display screen 444. Additionally, navigation bar 460 is arranged to be moved on display screen 444 by a user, and may be resized by the user.

In one embodiment, navigation bar 460 is translucent such that content associated with a shared desktop may be displayed under navigation bar 460. Navigation bar 460 is arranged to represent a shared desktop. A first icon 462 represents a display region, i.e., the portion of the shared desktop that is currently displayed on display screen 444. A second icon 464 represents an active region of the shared desktop. As shown, a representation of the active region of the shared desktop is not currently displayed on display screen 444. If a user of mobile device 440 activates second icon 464, as for example by tapping on second icon 464 or by otherwise selecting second icon 464, then display screen will effectively automatically scroll over the shared desktop until a representation of the active region is displayed on display screen 444. Second icon 464 essentially functions as a switch mechanism which allows a user to switch from what is currently displayed on display screen 444 to displaying a representation of the active region on display screen 444.

It should be appreciated that when the region displayed on display screen 444 is a representation of the active region of a shared desktop, first icon 462 may overlay second icon 464, or vice versa. In other words, when a user of mobile device 440 elects to display a representation of an active region of a shared desktop on display screen 444, first icon 462 and second icon 464 may overlap.

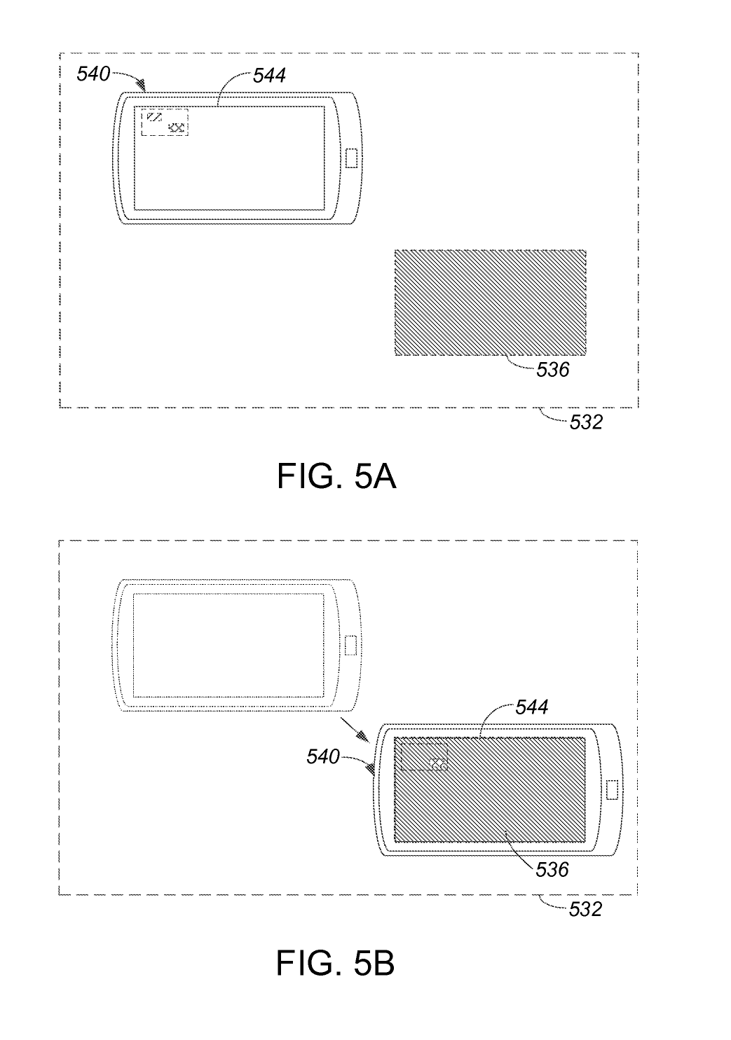

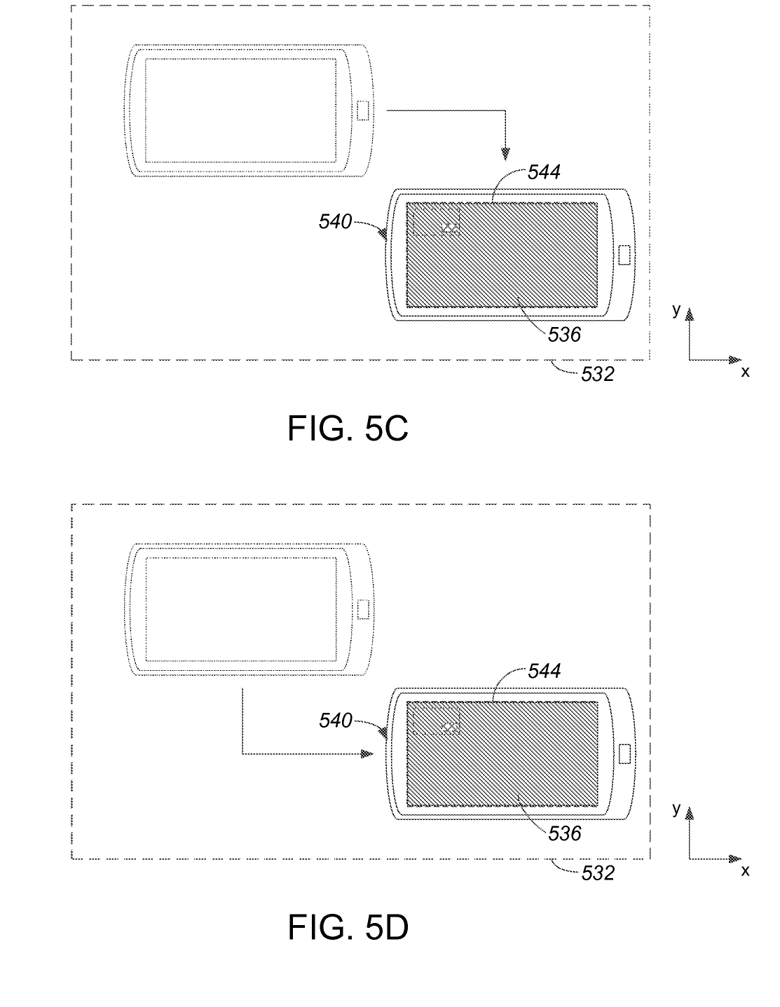

When a user of a mobile device elects to display a representation of an active region on a display screen of the mobile device, the display screen effectively scrolls over a shared desktop. FIG. 5A is a diagrammatic representation of a display screen of a mobile device portrayed relative to an active region of a shared desktop at a time t1 during a desktop sharing session in accordance with an embodiment. A shared desktop 532, which is shared with a mobile device 540 such that at least a portion of shared desktop 532 is displayed in a display region on a display screen 544 of mobile device 540, includes an active region 536. In the described embodiment, active region 536 corresponds to the area on shared desktop 532 that is currently being manipulated. It should be understood that display screen 544 is not actually physically positioned over shared desktop 532, but displays contents as if display screen 544 were positioned over shared desktop 532.

At a time t1, a representation of active region 536 is not displayed on display screen 544. If a user of mobile device 544 elects to display a representation of active region 536 on display screen 544, then display screen 544 effectively automatically scrolls over shared desktop 532 until display screen 544 is effectively centered over active region 536.

When a user elects to have display screen 544 automatically scroll, as for example but activating an auto-switch mode or by manually selecting an option to cause a representation of active region 536 to be displayed, the display screen 544 may scroll or effectively move over shared desktop 532 until display screen 544 is effectively positioned over active region 536. In the described embodiment, the scales associated with display screen 544 and shared desktop 532 are such that active region 536 substantially fills display screen 544.

When display screen 544 effectively moves over shared desktop 532 until display screen 544 is effectively positioned over active region 536, display screen 544 may effectively move in any suitable manner. For example, display screen 544 may effectively move along a shortest path to active region 536, display screen 544 may move horizontally and then vertically to active region 536, or display screen 544 may move vertically and then horizontally to active region 536. It should be appreciated that in some instances, moving along a shortest path to active region 536 may include substantially only horizontal movement or substantially only vertical movement.

FIG. 5B is a diagrammatic representation of a screen of a mobile device, e.g., screen 544 of mobile device 540 of FIG. 5A, relative to an active region of a desktop at a time t2 after substantially direct scrolling has enabled the active region to be displayed on the screen during a desktop sharing session in accordance with an embodiment. As shown, mobile device 540 may effectively move diagonally over shared desktop 532 until display screen 544 is effectively positioned such that a representation of active region 536 is displayed in display screen 544.

FIG. 5C is a diagrammatic representation of a screen of a mobile device, e.g., screen 544 of mobile device 540 of FIG. 5A, relative to an active region of a desktop at a time t2 after horizontal then vertical scrolling has enabled the active region to be displayed on the screen during a desktop sharing session in accordance with an embodiment. As shown, mobile device 540 may first move horizontally, as for example along an x-axis, and then vertically, as for example along a y-axis, until display screen 544 is effectively positioned such that a representation of active region 536 is displayed in display screen 544.

FIG. 5D is a diagrammatic representation of a screen of a mobile device, e.g., screen 544 of mobile device 540 of FIG. 5A, relative to an active region of a desktop at a time t2 after vertical then horizontal scrolling has enabled the active region to be displayed on the screen during a desktop sharing session in accordance with an embodiment. As shown, mobile device 540 may first move vertically, and then horizontally, until display screen 544 is effectively positioned such that a representation of active region 536 is displayed in display screen 544.

Although only a few embodiments have been described in this disclosure, it should be understood that the disclosure may be embodied in many other specific forms without departing from the spirit or the scope of the present disclosure. By way of example, when an auto-switch mode is activated, in lieu of automatically updating contents displayed in a display region of a mobile device each time an active region of a shared desktop is updated, the contents displayed in the display region may instead be automatically updated based on how much the active region has moved. For instance, an automatic update may occur when an active region has moved on a shared desktop more than a particular amount on the shared desktop, and an automatic update may not occur when the active region has moved on the shared desktop less than the particular amount. In other words, a display region may be automatically updated in some embodiments substantially only when an active region has moved significantly.

In one embodiment, a user of a mobile device may be provided with suggestions of when he or she may benefit from electing to display a representation of an active region of a shared desktop on the mobile device. For example, if a user has not elected to manually select an option to view a representation of an active region of a shared desktop for more than a predetermined amount of time, the user may be prompted to elect to view the representation of the active region. Alternatively, after a certain amount of time during which the user manually elects to display a representation of an active region of a shared desktop, the user may be prompted to elect to activate an auto-switch mode.

In some situations, there may be no update regions of a shared desktop identified within a particular amount of time. That is, a presenter in a desktop sharing session may not have recently manipulated his or her desktop. In one embodiment, when there are no update regions and, hence, no current active region, a previous active region may effectively be used as a current active region, at least until a presenter once again manipulates his or her desktop.

The size of an active region has generally been described in terms of the smallest possible rectangular region which encompasses a particular number of update regions or encompasses substantially all regions updated during a particular time frame. It should be appreciated, however, that a minimum size of for an active region may be specified. For example, instead of an active region having a minimum size effectively corresponding to the size of one update region or block, an active region may have a minimum size that is a predetermined number of regions or blocks.

In addition, while the shape of an active region has generally been described as being rectangular, the aspect ratio of the active region may also be specified in some embodiments. For instance, an active region may be defined to be the smallest possible rectangle which has a particular aspect ratio, e.g., an aspect ratio of five to three. It should be understood that when any suitable aspect ratio may be specified.

Although the shape of update regions and the shape of active regions have been described as being rectangular, the shape of update regions and the shape of active regions are not limited to being rectangular. In general, the shapes of update regions and active regions may be any suitable polygonal shape.

The embodiments may be implemented as hardware and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
establishing a communications session between a first endpoint and a second endpoint, the first endpoint being arranged to display a shared desktop, the second endpoint having a display screen, wherein the shared desktop is arranged to be shared during the communications session;
identifying an active region on the shared desktop, wherein the active region is part of the shared desktop;
providing an interface on the second endpoint arranged to obtain an input, wherein the input is arranged to indicate whether a representation of the active region is to be automatically displayed on the display screen in response to the input;
obtaining the input through the interface;
determining when the input indicates that the representation of the active region is to be automatically displayed on the display screen in response to the input; and
causing the representation of the active region to be displayed on the display screen when it is determined that the input indicates that the representation of the active region is to be automatically displayed on the display screen in response to the input, wherein the representation of the active region is automatically displayed on the display screen such that substantially only the representation of the active region is displayed on the display screen.

2. The method of claim 1 wherein the active region is an area on the shared desktop that has been manipulated within a particular amount of time.

3. The method of claim 1 wherein the shared desktop is divided into a plurality of blocks, and wherein the active region includes less than all of the plurality of blocks.

4. The method of claim 1 wherein determining when the input indicates that the active region is to be automatically displayed on the display screen in response to the input includes determining when the input indicates an auto-switch mode is to be activated.

5. The method of claim 4 further including:
identifying when the active region has been updated, wherein when the auto-switch mode is activated, the representation of the active region displayed on the display screen is automatically updated when the active region is updated.

6. The method of claim 1 wherein causing the representation of the active region to be displayed on the display screen includes automatically scrolling until the representation of the active region is displayed on the display screen.

7. The method of claim 1 wherein the display screen has an associated area, the method further including:
scaling the active region, wherein scaling the active region causes the representation of the active region to occupy approximately all of the associated area.

8. An apparatus comprising:
means for establishing a communications session between a first endpoint and a second endpoint, the first endpoint being arranged to display a shared desktop, the second endpoint having a display screen, wherein the shared desktop is arranged to be shared during the communications session;
means for identifying an active region on the shared desktop, wherein the active region is part of the shared desktop;
means for providing an interface on the second endpoint arranged to obtain an input, wherein the input is arranged to indicate whether a representation of the active region is to be automatically displayed on the display screen in response to the input;
means for obtaining the input through the interface;
means for determining when the input indicates that the representation of the active region is to be automatically displayed on the display screen in response to the input; and
means for causing the representation of the active region to be displayed on the display screen when it is determined that the input indicates that the representation of the active region is to be automatically displayed on the display screen in response to the input, wherein the representation of the active region is automatically displayed on the display screen such that substantially only the representation of the active region is displayed on the display screen.

9. A tangible, non-transitory computer-readable medium comprising computer program code, the computer program code, when executed, configured to:
establish a communications session between a first endpoint and a second endpoint, the first endpoint being arranged to display a shared desktop, the second endpoint having a display screen, wherein the shared desktop is arranged to be shared during the communications session;
identify an active region on the shared desktop, wherein the active region is part of the shared desktop;
provide an interface on the second endpoint arranged to obtain an input, wherein the input is arranged to indicate whether a representation of the active region is to be automatically displayed on the display screen in response to the input;
obtain the input through the interface;
determine when the input indicates that the representation of the active region is to be automatically displayed on the display screen in response to the input; and
cause the representation of the active region to be displayed on the display screen when it is determined that the input indicates that the representation of the active region is to be automatically displayed on the display screen in response to the input, wherein the representation of the active region is automatically displayed on the display screen such that substantially only the representation of the active region is displayed on the display screen.

10. The tangible, non-transitory computer-readable medium comprising computer program code of claim 9 wherein the active region is an area on the shared desktop that has been manipulated within a particular amount of time.

11. The tangible, non-transitory computer-readable medium comprising computer program code of claim 9 wherein the shared desktop is divided into a plurality of blocks, and wherein the active region includes less than all of the plurality of blocks.

12. The tangible, non-transitory computer-readable medium comprising computer program code of claim 9 wherein the computer program code configured to determine when the input indicates that the active region is to be automatically displayed on the display screen in response to the input is further configured to determine when the input indicates an auto-switch mode is to be activated.

13. The tangible, non-transitory computer-readable medium comprising computer program code of claim 12 further including computer program code configured to:
identify when the active region has been updated, wherein when the auto-switch mode is activated, the representation of the active region displayed on the display screen is automatically updated when the active region is updated.

14. The tangible, non-transitory computer-readable medium comprising computer program code of claim 9 wherein the computer program code configured to cause the representation of the active region to be displayed on the display screen is further configured to automatically scroll until the representation of the active region is displayed on the display screen.

15. The tangible, non-transitory computer-readable medium comprising computer program code of claim 9 wherein the display screen has an associated area, the apparatus further including computer program code configured to scale the active region, wherein the computer program code configured to scale the active region causes the representation of the active region to occupy approximately all of the associated area.

16. An apparatus comprising:
a processing arrangement; and
a logic module, the logic module configured to cooperate with the processing arrangement to support a desktop sharing session that involves a mobile device with a display screen having a display region, wherein the logic module is further configured to identify an active region associated with a shared desktop and to determine when a representation of the active region is to be automatically rendered in the display region, wherein the logic module is still further configured to cause the representation of the active region to be automatically rendered in the display region such that the representation of the active region approximately fills the display region when it is determined that the representation of the active region is to be automatically rendered in the display region, the active region being less than all of the shared desktop.

17. The apparatus of claim 16 further including an interface, the interface being configured to obtain information that identifies the active region.

18. The apparatus of claim 17 wherein the interface is configured to obtain the information from a device that hosts the shared desktop.

19. The apparatus of claim 16 further including an interface, the interface being configured to obtain information from the mobile device, the information being arranged to indicate whether the representation of the active region is to be automatically rendered in the display region.

20. The apparatus of claim 19 wherein the information arranged to indicate whether the representation of the active region is to be automatically rendered in the display region is further arranged to indicate whether the representation of the active region is to be automatically updated when the active region is updated.
